(19) United States
(12) Patent Application Publication
(10) Pub. No.: US 2008/0284254 A1
(43) Pub. Date: Nov. 20, 2008

(54) Stator Packet For a Magnetic Levitation Train

(76) Inventors: Kurt Munk, Grenzach (DE); Michael Tum, Kassel (DE)

Correspondence Address: MICHAEL J. STRIKER, 103 EAST NECK ROAD, HUNTINGTON, NY, 11743, US

(21) Appl. No.: 10/592,816

(22) PCT Filed: Mar. 15, 2005
(86) PCT No.: PCT/DE05/00462

§ 371 Date: Jul. 30, 2008

(30) Foreign Application Priority Data
Mar. 19, 2004 (DE) 10-2004013-995.4

(51) Int. Cl. H02K 41/02

(52) U.S. Cl. 310/12

(57) ABSTRACT

A stator packet for magnetic levitation vehicles is described. The stator packet has a plurality of sheets (1) made from steel, two end sheets (14, 15) having perforations (16) at its ends and an anti-corrosion layer (2) at least partially surrounding the stator packet and will adhering thereto because of the perforations (16).

The invention relates to a stator packet of the species mentioned in the preamble of claim 1.

Stator packets of this type, particularly those of long stator linear motors, are comprised of a sheet metal packet formed by sheet metal laminations and at least partially wrapped by an anti-corrosion layer. The anti-corrosion layer is attached, for example, by inserting the sheet stack into a cavity of a tool and by filling the cavity with a plastic material, particularly with a two-component cast resin (e.g. DE 197 03 497 A1). To precisely position the metal sheet packet in the tool it is common practice to lay spacer elements made of a porous material, e.g. fibre glass tissue and/or mats, on the end lamellae positioned at its broad sides before filling the cast resin into the cavity. These spacer elements are soaked with cast resin as the casting process proceeds, thus creating mechanically firm external cast resin walls of the finished stator packet after hardening. Therefore, apart from their task of positioning the stator packet in the tool, the spacer elements also serve the purpose of providing the end sheets located at the broad sides of the stator packet with a well adhering anti-corrosion layer, even if these end sheets have smooth surfaces, which is also usual.

Attaching the fibre glass mats involves additional cost of material and fabrication. Moreover, the use of fibre glass mats increases the requirements with respect to the gas removal process and deteriorates the distribution of resin during the casting process, which is the reason why this process is done by a relatively expensive pressure gelation process.

In contrast therewith, the technical problem of the present invention is ensuring good adhesion of the anti-corrosion layer on smooth outer surfaces of the end lamellae even without applying fibre glass tissues and also if a casting process is used which can be carried out without any pressure.

To solve this problem the stator packet designated hereinabove is characterized in that its end sheets or lamellae are provided with perforations.

The invention bears the advantage that good adhesion of the anti-corrosion layer is obtained even directly at the broad smooth surfaces of the end lamellae, thus achieving higher productivity as the casting process is accelerated. In the process, the anti-corrosion layer not only adheres by close material fit, but also by close form fit at the end lamellae, so that a high force of detachment is achieved. This is particularly true if a favourable value is chosen in a given application for the ratio of the area occupied by the perforations versus the ratio of the residual surface of lamellae.

Other advantageous features of the present invention become evident from the sub-claims.

An embodiment of the invention is explained below in greater detail and based on the appending drawings, wherein:

FIG. 1 shows a perspective view of individual sheets of a stator packet being the subject of this invention;

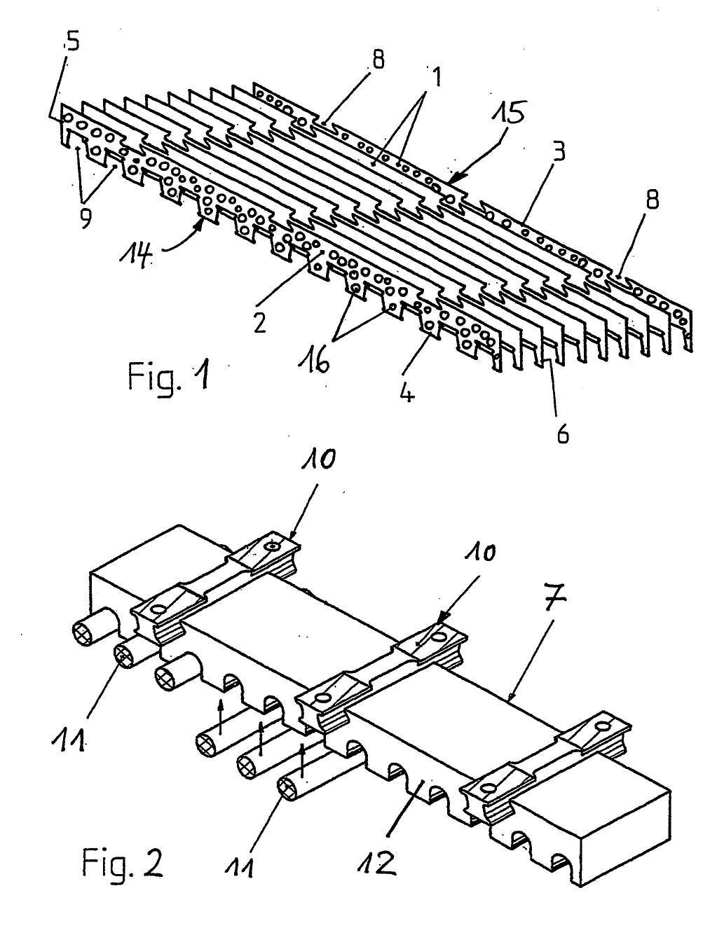

FIG. 2 shows a finished stator packet according to FIG. 1 after an anti-corrosion layer has been applied;

FIG. 3 shows an end lamellae according to this invention in a perspective view;

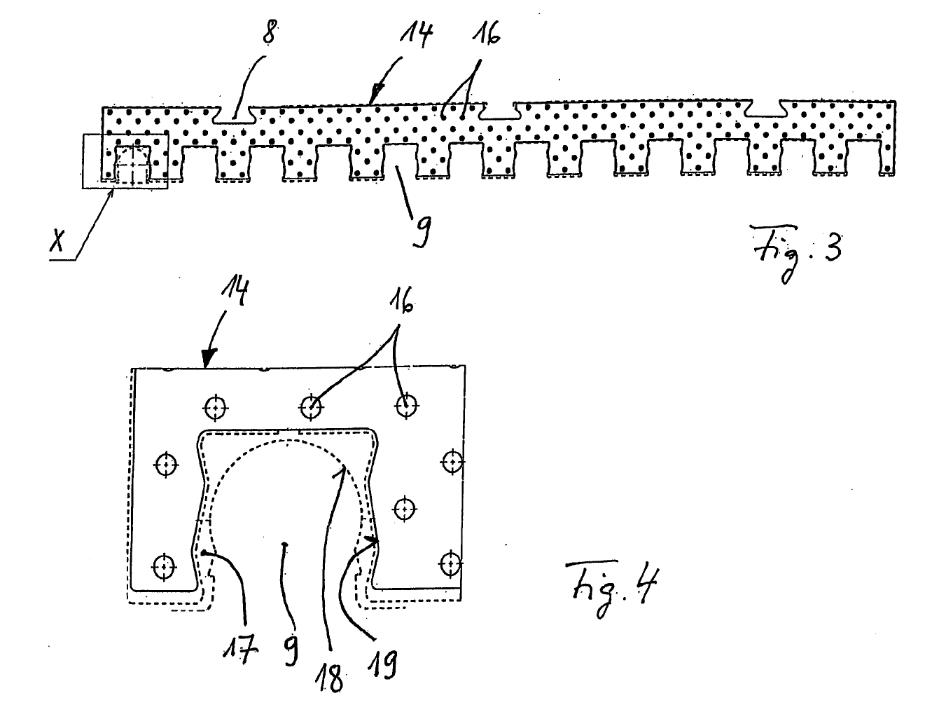

FIG. 4 shows an enlarged detail X of FIG. 3.

As shown in FIG. 1 and FIG. 2, a stator packet for a long stator linear motor of a magnetic levitation vehicle is comprised of a plurality of metal sheets or lamellae 1, e.g. approximately 0.5 mm thick, that are obtained by punching-out from a ferromagnetic metal sheet strip. Lamellae 1, as shown in this embodiment, have substantially identical dimensions and have one front-end and one rear-end broad side 2 each and one small top edge 3, bottom edge 4 as well as two side edges 5 and 6 each in a circumferential direction. The broad sides 2 have a large area and as compared with edges 3 to 6, their area is much larger. Lamellae 2 are stacked in a manner not described in detail hereunder to form metal sheet packs 7 (FIG. 2) by laying them next to each other with their front-end and rear-end broad sides 2, respectively, and aligning them in a flush arrangement to each other. The number of lamellae 1 applied depends on the electrical and magnetic properties demanded for the long stator linear motor.

When produced by punching, lamellae 1 are provided with recesses 8 at their top edges 3 and with recesses 9 at their bottom edges. Upon stacking, the recesses 8 each form grooves to accommodate traverses (crosspieces) 10 (FIG. 2) that substantially are of double-T-shape, while the recesses 9 each form grooves to accommodate the strands of a three-phase alternate current winding being comprised of electrical conductors 11.

Besides, the finished stator pack 7 according to FIG. 2 is wholly or partly wrapped by an anti-corrosion layer 12 that is not outlined hereunder in greater detail.

Stator packs 7 of this type are commonly known (e.g. DE 197 03 497 A1) and therefore they need not be explained in greater detail to experts in this field.

At its front-end and rear-end side, the stator packet 7 is provided with a front and rear end lamella 14 and 15 each. In accordance with this invention, the end lamella 14 (FIG. 3 and FIG. 4) is provided with perforations 16 that are preferably configured as holes having a circular cross-section, but which may also be comprised of holes having different cross-sections, e.g. oblong holes, slots or the like. In particular, the holes may be metal sheet outbreaks of a versatile geometric type and contour, and it is even possible to provide differently large and/or differently shaped perforations 16 within one and the same end lamella 14. The perforations 16 are expediently fabricated by punching when punching the end lamella 14. As particularly shown on FIG. 3, the end lamella 14 is expediently provided with a large number of perforations 16 having cross-sections that are small as compared with the dimensions of the end lamella 14. Accordingly, the perforations 16 are preferably spread substantially evenly across the entire broad side 2.

Preferably, the end lamella 15 is shaped exactly like end lamella 14.

By way of said perforations 16, it is ensured that the anti-corrosion layer 12 which is subsequently applied and which consists of a cast resin, for example, will also adhere well to the smooth broad sides 2 of the end lamellae 14, 15 by mechanical anchoring, because the casting material penetrates into the perforation 16 and virtually gets hooked-up to the rough hole walls obtained on punching, thus creating at least partly a close form fit connection. A firm bond is thus obtained which is similarly firm as it is in the area of the top, bottom and side edges 3 to 6 that have comparably many crevices due to the punching cuts. The number, magnitude and distribution of the perforations 16 on the broad side 2 should be chosen depending on the desired force of detachment for the anti-corrosion layer 12.

Reference numerals 17 in FIG. 4 indicate an insulation protection layer by which the stator pack is surrounded at least wrapped partly and particularly in the area of the recesses 9. It becomes evident therefrom that the lower recesses 9 (FIG. 1) can be given a contour 18 by applying the cast resin layer 17 that is different to the inner contour 19 of the original recess 9 in the metal sheet blank. Thereby it is possible to provide the sheets 1 with a contour 19 which is the most favourable one with respect to electrical and/or magnetic aspects, while the inner contour 18 is so configured by the casting process as it is expedient and suitable for the subsequent pressing of conductors 11.

The invention is not limited to the described embodiment that can be diversified in a plurality of ways. In particular, this is valid for the described fabrication of the stator packet by applying the pressure gelation method. Instead, and in contrast with DE 197 03 497 A1, the lamellae 1 can be connected to each other already prior to the casting process to form a solid packet and be provided with the intermediate layers required for electrical isolation already before applying the anti-corrosion layer 12. In that case, the casting process can be carried out even pressure-less in an open-top cavity of a tool and can thus be accelerated. Moreover it would be possible to give the perforations 16 a shape that is open at the rim, i.e. to let it border at one of the edges 3 to 6. If so, one should above all aim at a favourable voltage distribution. Furthermore, it is expedient to choose the outer contours of the end lamellae 14, 15 a little bit smaller, particularly and for example 1 mm each all around smaller than the outer contours of the other lamellae 1 in order to reduce notch stresses and, consequently, the tendency of crack formation and/or to allow for rounding-off the shear edge. It is also possible to fabricate the end lamellae 14, 15 of a material different to that used for the other lamellae 1. Finally it is self-explanatory that the different features can also be applied in combinations other than those described and shown hereinabove.

1. A stator packet for magnetic levitation vehicles comprising a plurality of ferromagnetic lamellae (1), having one end lamella each (14, 15) at its ends and being wrapped by an anti-corrosion layer (12) at least in the area of said end lamellae (14, 15), characterized in that said end lamellae (14, 15) are provided with perforations (16).

2. A stator packet according to claim 1, characterized in that said perforations (16) are comprised of metal sheet outbreaks having pre-selected contours.

3. A stator packet according to claim 1, characterized in that said end lamellae (14, 15) have a plurality of perforations (16) distributed across their surface.

4. A stator packet according to claim 1, characterized in that both end lamellae (14, 15) have a slightly smaller outer contour as compared with the remaining metal sheet packet (7).

5. A stator packet according to claim 4, characterized in that the outer contour is by approximately 1 mm smaller.

6. A stator packet according to claim 1, characterized in that said perforations (16) are configured with a pre-selected ratio of area versus perforation.
